(19) United States
(12) Patent Application Publication
(10) Pub. No.: US 2004/0187925 A1
(43) Pub. Date: Sep. 30, 2004

(54) Plumbing trap after-valve

(76) Inventor: Roger R. Newman, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/401,952

(22) Filed: Mar. 31, 2003

(51) Int. Cl. F16K 13/00

(52) U.S. Cl. 137/247.13

(57) ABSTRACT

In one aspect, the invention is directed to a plumbing drain system comprising a drain line and a valve. The drain line has a drain inlet. The valve is situated in the drain line, spaced from the drain inlet. The valve is positionable between an open position wherein liquid flow is permitted through the drain line and a closed position wherein liquid flow is substantially prevented through the drain line, so that a portion of the drain line upstream of the valve can hold a drain line cleaning solution for a selected period of time.

### FIELD OF THE INVENTION

This invention relates to a cleaning assistance apparatus, such as an after-valve that can be installed downstream from any type of plumbing trap, permitting drains of plumbing fixtures, such as kitchen sinks and the like, to be cleaned when using a cleaning solution.

### BACKGROUND OF THE INVENTION

It is well known to provide drains for a variety of plumbing fixtures, with some sort of trap, to ensure that, at all times, the line is closed by water retained in the line. This is achieved by simply providing a trap whose highest point is lower than the immediately upstream and downstream portions of the drain line or conduit. Then, even after discharged water has passed through the drain line, the trap will be full of water, to close off the line, as shown in FIG. 1. This prevents offensive odors that originate from build-up downstream from the trap from venting out through a drain inlet in the sinks. Such traps are commonly identified as P-traps or U-traps, due to their characteristic shape. Odors, however, often emanate from sinks and other plumbing fixtures regardless of the presence of a trap.

An ongoing battle that is being waged, in kitchens, bathrooms and other areas where plumbing fixtures are present, is the seemingly hopeless task of controlling the bad odors emanating from the drains of plumbing fixtures, such as, for example, kitchen sinks. All kinds of strong smelling cleaning agents are used to try to overcome this problem, but at best, only very temporary relief of any odors can be achieved, largely due to the strong smell of the cleaning agent itself, which masks the bad odors.

The cleaning agent can do little more than clean the plumbing trap itself underneath the sink, and even that is not done very efficiently. Consequently, there is a constant need to pour cleaning agents down the drains. Indeed, the smells emanating from some sinks can get so dreadful that it becomes necessary to pour cleaning agents into the drains regularly.

A representational drawing of a typical double sink system that is used in most kitchens is shown in FIG. 1. The two sinks each have drain inlets that are connected to the center outlet of a drain line, which combines the two drain inlets into a single pipe that is connected to a standard plumbing trap before being joined into the vented drainage system of the house. As explained above, the purpose of the plumbing trap is to provide a water barrier between the vented drainage system of the house and the sinks. This is in order to prevent any bad odors in the vented drainage system downstream from the trap from escaping out through the drain inlets of the sinks.

As shown in FIG. 2, after a prolonged period of use, there can be a substantial build-up of matter that is deposited on the inside walls of the drain line upstream from the trap, within the trap, and also downstream from the trap. These deposits of matter can consist of all manner of foul and disease-ridden substances, which can grow and fester.

The plumbing trap is long established, and it works very well indeed for its intended purpose of blocking the passage of bad odors that originate downstream from the trap, preventing those bad odors from reaching the drain line upstream from the trap and escaping out through the drain inlets of the sinks. Unfortunately, the plumbing trap does nothing whatever to prevent any of the bad odors that originate from build-up inside the pipes upstream from the trap, from escaping out through the drain inlets of the sinks. It is these bad odors that are the cause of so much distress and frustration when dealing with drain lines, such as, for example, sink drain lines.

Furthermore, the build-up of matter on the inside walls of the drain lines can become substantial enough over time, to partially or entirely restrict the flow of drain liquids through the drain line. However, this build-up occurs regardless of the presence of the trap.

As shown in FIG. 3, when a cleaning solution (such as caustic soda or sodium hypochlorite) is poured into the drain line of the sink, it all immediately collects only in the trap itself, and any excess merely passes through the vented drainage system of the house and into the sewers. Virtually none of the cleaning solution stays in the pipes upstream from and downstream from the trap, and therefore the residence time required for the cleaning agent to work on the build-up is not provided. Thus a significant cleaning of these portions of drain line is not achieved. Consequently, as shown in FIG. 4, after the cleaning solution has been flushed away, only the trap itself has been cleaned, and all of the matter deposits remain on the inside walls of the drain line upstream from and downstream from the trap, even after repeated cleaning. Thus, the offensive odors from the matter upstream from the trap will continue to emanate out from the drain inlets of the sinks. Furthermore, the build-up of matter can continue to grow and restrict the flow of drain liquids through the drain lines.

The build-up of foul and disease-ridden matter inside of the drain line upstream from the plumbing traps of plumbing fixtures, such as kitchen sinks and the like, can not only result in unpleasant odors emanating from the drain lines of those kitchen sinks, but it could also be a health hazard, and can add to indoor pollution. In those situations where offensive odors from the drain lines of kitchen sinks have become unbearable, and strong smelling cleaning agents are constantly being poured into those drains, this excessive use of strong smelling cleaning agents may itself be contributing to the indoor pollution as well.

There is a need for an apparatus to facilitate the cleaning of the drain line of plumbing fixtures, such as kitchen sinks, bathroom sinks, urinals, showers, bathtubs, liquid storage tanks.

### SUMMARY OF THE INVENTION

In a first aspect, the invention is directed to a plumbing drain system comprising a drain line, a trap and a valve. The drain line has a drain inlet. The trap is downstream from the drain inlet and is for holding a sufficient volume of liquid to close off the drain line. The valve is situated in the drain line, downstream from the drain inlet. The valve is positionable between a normally open position wherein liquid flow is permitted through the drain line and a closed position wherein liquid flow through the drain line is substantially prevented, so that a portion of the drain line upstream of the valve and including the trap can retain a drain line cleaning solution for a selected period of time.

In a second aspect, the invention is directed to a plumbing drain line cleaning apparatus for use with a drain line cleaning solution to clean a drain line. The apparatus includes a valve. The valve is mountable in the drain line, downstream from the inlet to the drain line. The valve is positionable between an open position wherein liquid flow is permitted through the drain line and a closed position wherein liquid flow is substantially prevented through the drain line, so that a portion of the drain line upstream of the valve can hold the drain line cleaning solution for a selected period of time.

In a third aspect, the invention is directed to a kit of parts for use with a cleaning solution to clean a drain line, the drain line having a drain inlet. The kit of parts comprises a section of drain line and a valve integrally mounted in the section of drain line. The valve includes a plunger housing and a plunger, the plunger housing is connected to and extends from the section of drain line. The plunger has a plunger body that is movably mounted in the plunger housing and sealingly engaged with the plunger housing to prevent liquid flow therethrough. The plunger body is movable in the plunger housing between an extended position wherein the plunger body extends into the section of drain line to substantially block liquid flow therethrough, and a retracted position wherein the plunger is substantially removed from the section of drain line to permit liquid flow therethrough. The plunger further includes a handle for moving the plunger body between the retracted and the extended positions.

In a fourth aspect, the invention is directed to a method for cleaning a drain line system, the drain line system including a drain line having a drain inlet, the drain line system including a trap situated in the drain line, the method comprising:

closing the drain line off to flow therethrough, at a point of closure that is downstream from the trap;

filling the drain line with cleaning solution, so that substantially all of the drain line upstream of the point of closure is filled with cleaning solution; and

opening the drain line to flow therethrough after a selected period of time corresponding to the time required for the cleaning solution to clean the drain line.

### DESCRIPTION OF THE DRAWINGS

For a better understanding of the present invention and to show more clearly how it may be carried into effect, reference will now be made to the accompanying drawings, in which:

FIG. 1 shows a side sectional view of a typical double sink system of the prior art, that is used in some kitchens;

FIG. 2 shows a side sectional view of the double sink system shown in FIG. 1, after a prolonged period of use, and illustrates the build-up of matter that occurs inside of the drain line and the trap, as well as the resultant offensive odors;

FIG. 3 shows a side sectional view of the double sink system shown in FIG. 1, with cleaning solution inside the trap;

FIG. 4 shows a side sectional view of the double sink system shown in FIG. 1, after the cleaning solution has been flushed away;

FIGS. 5a and 5b show side sectional views of a plumbing trap after-valve in accordance with a first embodiment of the present invention, having a centrally pivoted flap in open and closed positions;

FIGS. 6a and 6b show side sectional views of a plumbing trap after-valve in accordance with a second embodiment of the present invention, having an end pivoted flap in open and closed positions;

FIGS. 7a and 7b show side sectional views of a plumbing trap after-valve in accordance with a third embodiment of the present invention, having a vertical sliding plate that can be moved up or down in order to open or close the valve;

FIGS. 8a and 8b show side sectional views of a plumbing trap after-valve in accordance with a fourth embodiment of the present invention, having a rotatable plug section with a pass-through conduit therethrough, whereby the plug can be turned from an open position wherein the pass-through conduit is aligned with the drain line, thereby permitting flow therethrough, to a closed position wherein the pass-through conduit is not aligned with the drain line, preventing flow therethrough;

FIGS. 9a and 9b show side sectional views of a plumbing trap after-valve in accordance with a fifth embodiment of the present invention, having a vertically sliding plunger that can be moved up and down in order to open and close the valve;

FIG. 10 shows a side sectional view of a double sink system having the plumbing trap after-valve shown in FIGS. 9a and 9b installed behind the trap;

FIG. 11 shows a side sectional view of the proposed double sink system after a prolonged period of use, with a build-up of matter that occurs inside of the drain line and the trap, as well as the resultant offensive odors;

FIGS. 12, 13 and 14 illustrate a procedure in accordance with a sixth embodiment of the present invention, to clean the drain line of the double sink system shown in FIG. 11;

FIG. 15 shows a perspective view of a plumbing trap after-valve in accordance with a seventh embodiment of the present invention, for use with plumbing connections that are soldered or glued or the like;

FIG. 15b shows a perspective view of the plumbing trap after-valve shown in FIG. 15, with an optional knob;

FIG. 16 shows an exploded perspective view of the plumbing trap after-valve of FIG. 15;

FIG. 17 shows a perspective view of a plumbing trap after-valve in accordance with an eighth embodiment of the present invention, for use with compression type plumbing connections;

FIG. 17b shows a perspective view of the plumbing trap after-valve shown in FIG. 17, with an optional knob;

FIG. 18 shows an exploded perspective view of the plumbing trap after-valve shown in FIG. 17;

FIG. 19 shows an exploded side view of the plumbing trap after-valve shown in FIG. 17;

FIG. 20 shows an exploded end view of the plumbing trap after-valve shown in FIG. 17;

FIG. 21 shows an exploded top view of the plumbing trap after-valve shown in FIG. 17;

FIG. 22a shows a top view of the plumbing trap after-valve shown in FIG. 17;

FIG. 22b shows a side view of the plumbing trap after-valve shown in FIG. 17 in the fully open position;

FIG. 22c shows an end view of the plumbing trap after-valve shown in FIG. 17 in the fully open position;

FIG. 23a shows a side view of the plumbing trap after-valve shown in FIG. 17 in the fully closed position;

FIG. 23b shows an end view of the plumbing trap after-valve shown in FIG. 17 in the fully closed position;

FIG. 24 shows a top view of plumbing trap apparatus in accordance with a ninth embodiment of the present invention, having a plumbing trap, a section of drain line and a plumbing trap after-valve;

FIG. 25 shows a side view of the plumbing trap apparatus shown in FIG. 24, with the plumbing trap after-valve in the fully open position;

FIG. 26 shows a side view of the plumbing trap apparatus shown in FIG. 24, with the plumbing trap after-valve in the fully closed position; and

FIG. 27 shows optionally included attachment surfaces on two portions of the plumbing trap after-valve.

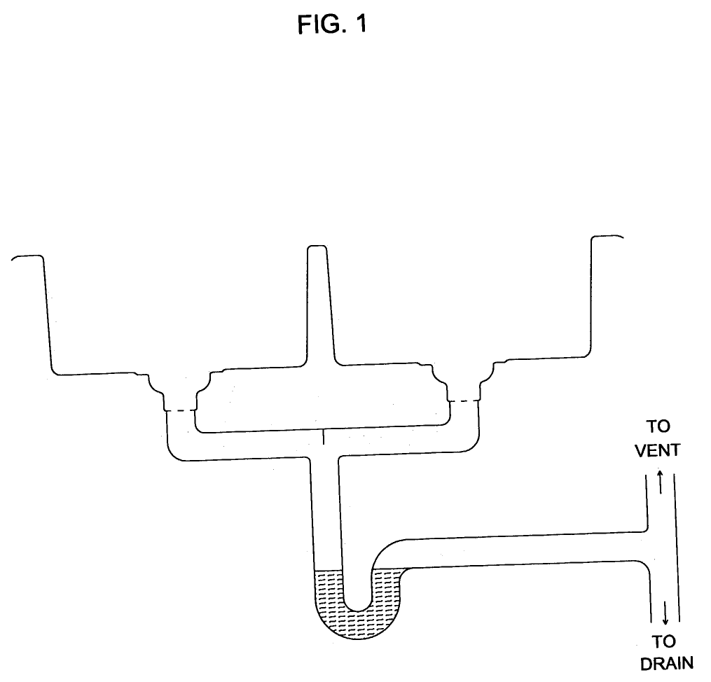

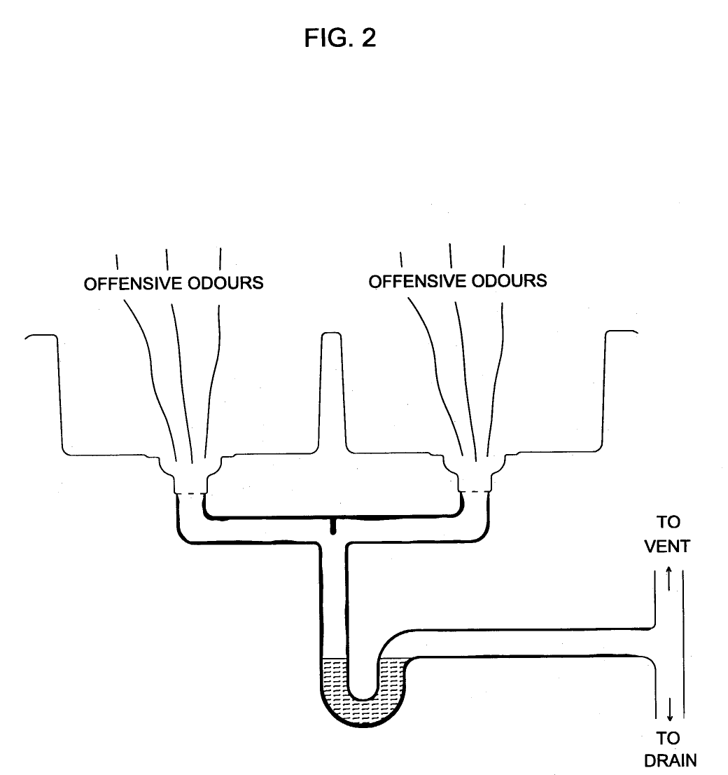

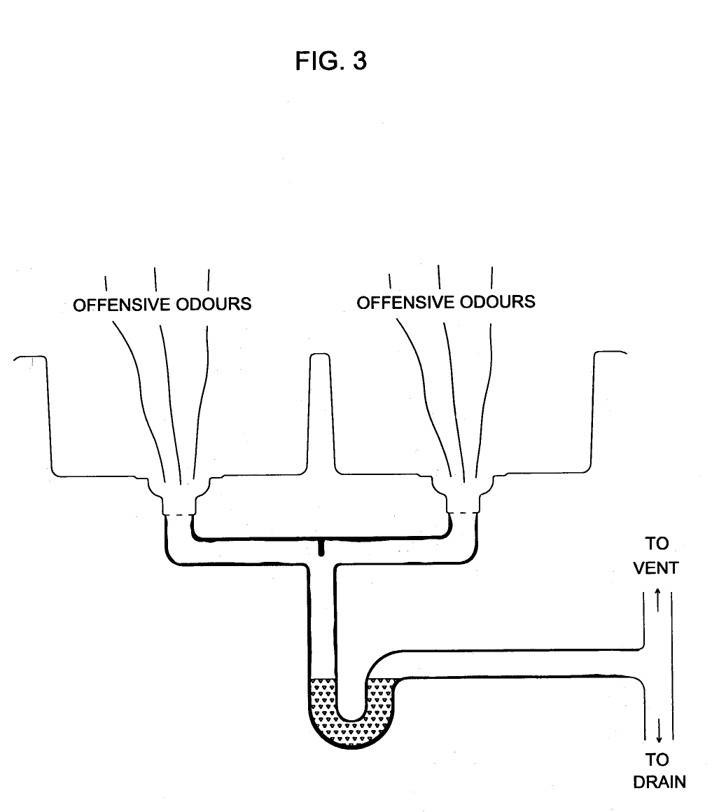

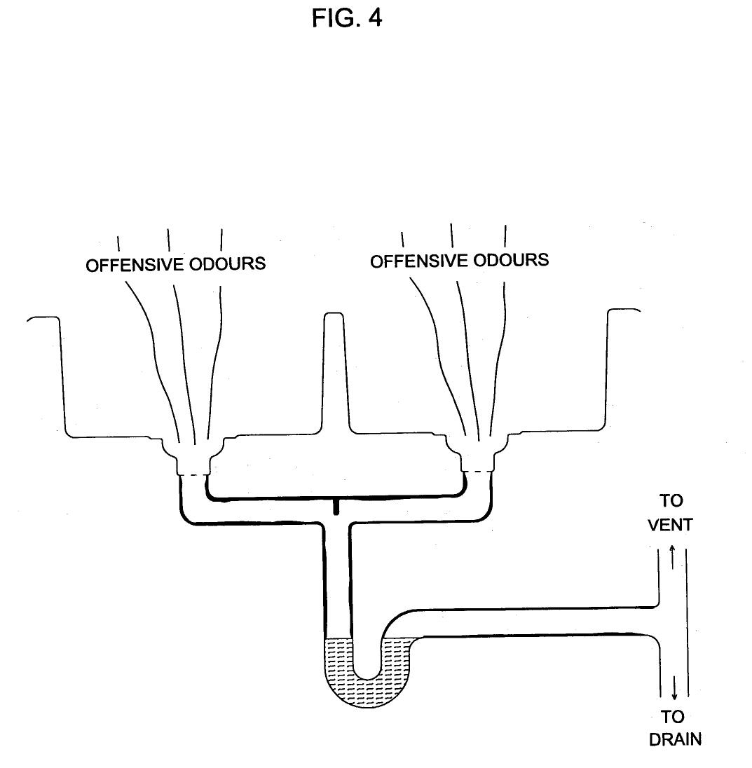

### DESCRIPTION OF THE PREFERRED EMBODIMENT

Reference is made to FIGS. 9a and 9b, which show a plumbing trap after-valve 10 in accordance with an embodiment of the present invention.

The plumbing trap after-valve 10 may be located in a drain line 12 downstream from a plumbing trap 14. Alternatively, the plumbing trap after-valve 10 may be located immediately upstream from the plumbing trap 14, or even within the trap 14 itself.

The plumbing trap after-valve 10 is a cleaning assistance apparatus. The installation of the plumbing trap after-valve 10 in the drain line 12 downstream from a plumbing trap 14, permits the drain line 12 upstream from the plumbing trap 14 to be properly cleaned. The plumbing trap after-valve 10 is a device for shutting off the flow of drain liquids through the drain line 12.

The plumbing trap after-valve 10 comprises plunger 16 that may slide inside a plunger housing 18, between an open position, as shown in FIG. 9a and a closed position as shown in FIG. 9b. The plunger housing 18 may be connected to a portion of the drain line 12. When the valve 10 is in the open position, the flow of drain liquids through the drain line 12 is unimpeded. When the plumbing trap after-valve 10 is in the closed position, the flow of drain liquids is substantially prevented from passing through the drain line 12.

The plunger housing 18 and the plunger 16 may extend vertically upwards from the drain line 12, downstream from the trap 14. This will inhibit drain liquids from accumulating in the plunger housing 18 when the valve 10 is in the open position. Alternatively, the plunger housing 18 and the plunger 16 may extend, for example, horizontally outwards from the side of the drain line 12. As another alternative, they may extend downwards from underneath the drain line 12, or at any suitable angle from the drain line 12.

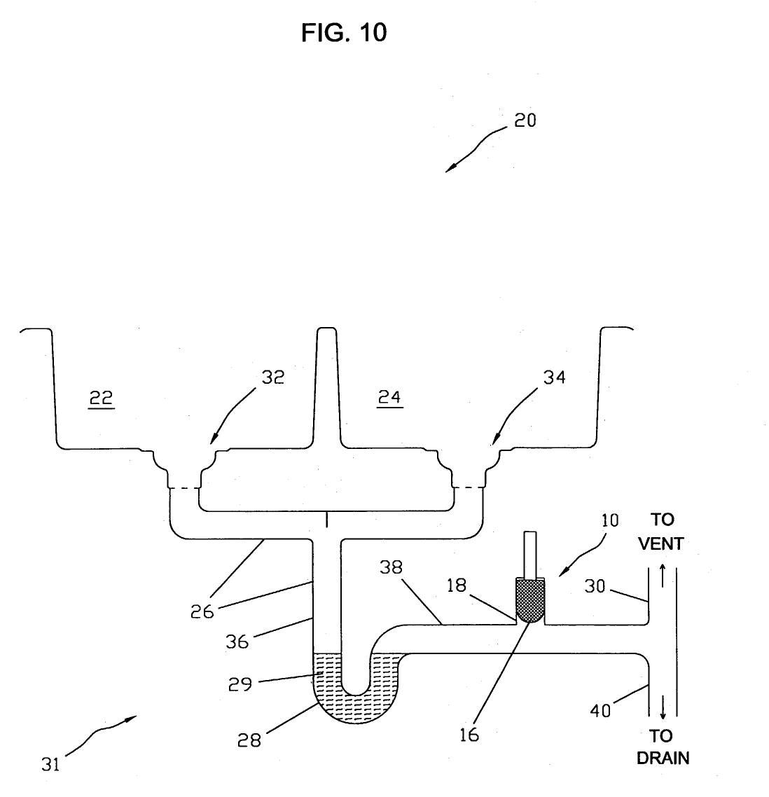

Reference is made to FIG. 10. A double sink system 20 includes the valve 10, a pair of sinks 22 and 24, a drain line 26, a trap 28 and an optional vent line 30. The valve 10, the drain line 26, the trap 28 and the optionally included vent line 30 make up a plumbing drain system 31. The drain line 26 includes two drain inlets 32 and 34, one of which is positioned in each sink 22 and 24. A first portion 36 of the drain line 26 may extend generally downwards from the drain inlets 32 and 34 to the inlet of the trap 28. A second portion 38 of the drain line 26 may extend generally horizontally from the outlet of the trap 28 to the vent line 30. The vent line 30 preferably connects to the top of the drain line 26, to inhibit the flow of drain liquids therein. A third portion 40 of the drain line 26 extends from the vent line 30 to a drain, such as, for example a municipal drain (not shown).

The plumbing trap after-valve 10 is shown in the open position. In this position, the sinks may be used as they would normally. Any bad odors originating from the vented drainage system downstream from the trap 28 are blocked by the water 29 in the trap 28 and are thus prevented from escaping out through the drains of the kitchen sinks.

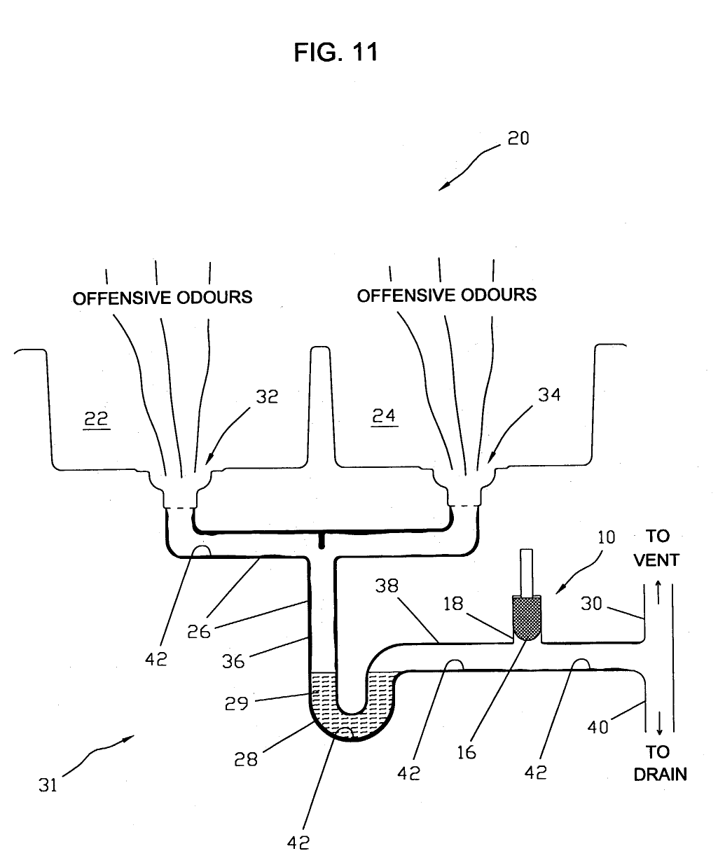

Reference is made to FIG. 11. After a prolonged period of use, there may be a substantial build-up of matter 42 that is deposited on the inside walls of the drain line 26 upstream from the trap 28, within the trap 28, downstream from the trap 28, and also downstream from the valve 10. The offensive odors caused by the build-up of matter 42 in the drain line 26 upstream from the trap 28 emanate from the drain inlets 32 and 34 of the sinks 22 and 24.

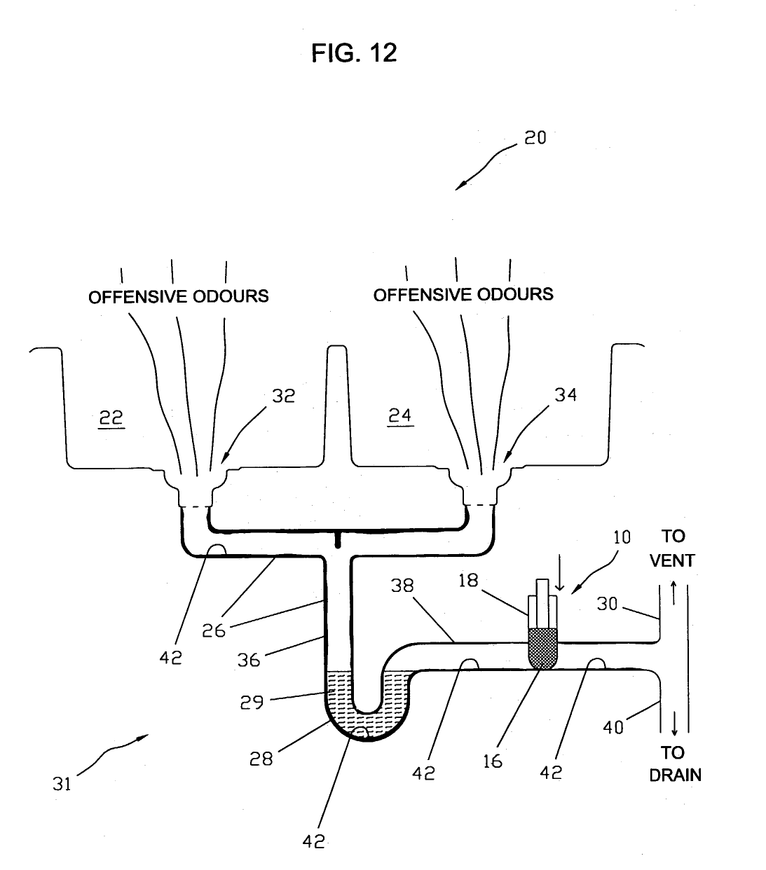

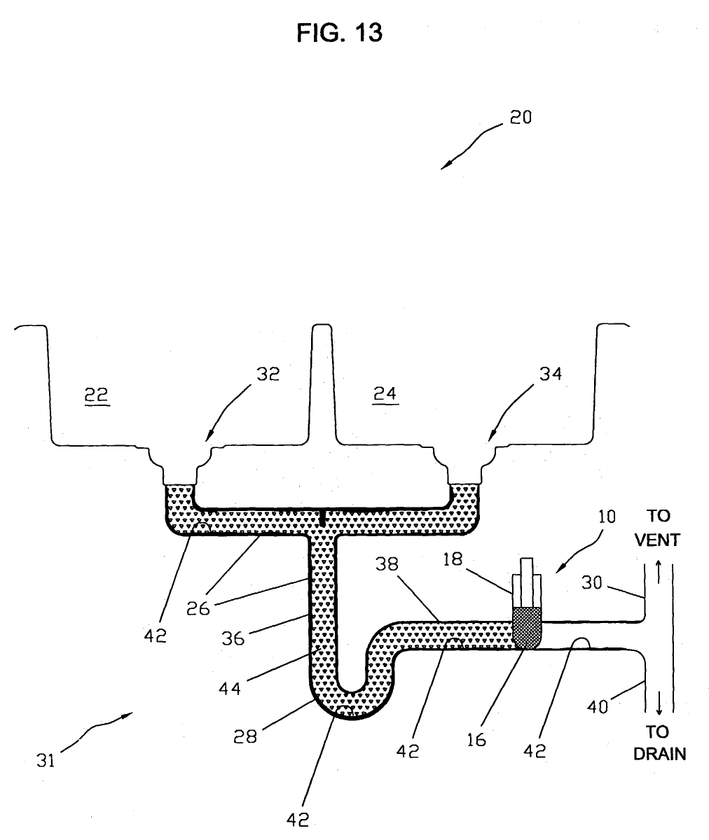

Reference is made to FIGS. 12, 13 and 14, which illustrate a method for cleaning drain line 26. Referring to FIG. 12, a first step in the method for cleaning the drain line 26 includes moving the plunger 16 of the valve 10 to the closed position to block off flow in the drain line 26. Referring to FIG. 13, a second step in the method includes pouring a sufficient amount of cleaning solution 44 into one or both drain inlets 32 and 34 in the sinks 22 and 24, until the level of cleaning solution 44 reaches the tops of the drain inlets 32 and 34. As can be seen, the cleaning solution 44 fills all of the drain line 26 that is upstream of the valve 10, including the plumbing trap 28, and the cleaning solution substantially remains there until the valve 10 is opened again. Usually about 20 minutes is sufficient time for the cleaning solution 44 to properly attack and destroy the build-up of matter inside the drain line 26 and also inside the plumbing trap 28.

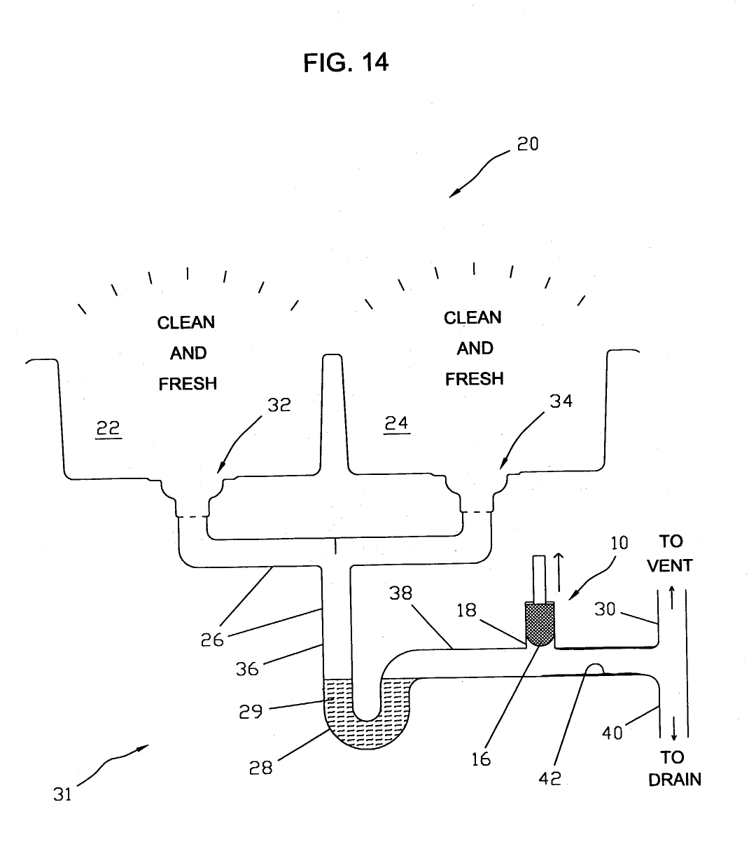

Referring to FIG. 14, a third step may be carried out after the desired time has elapsed. The third step comprises opening the valve 10 to release the cleaning solution 44, including the destroyed remnants of the matter, into the remainder of the vented drainage system and on into the sewers. Finally, the drain line 26 of the sinks 22 and 24 may be flushed through with clean water, and, as shown in FIG. 14, the sinks 22 and 24 may afterwards be clean and fresh and ready for normal use again.

The offensive odors will have been eliminated because the cleaning solution was provided with a suitable residence time in contact with the build-up of matter 42 to remove substantially all of the matter from the drain line 26 upstream from the trap 28, within the trap 28, and between the trap 28 and the valve 10. Any matter 42 that remains on any of the drain line 26 is located downstream of the valve 10. Thus, any offensive odors that might originate from such matter 42 would be blocked by the water in the plumbing trap 28. Furthermore, the matter 42 that is downstream from the valve 10 might be reduced somewhat by the sudden release of cleaning solution 44 when the valve 10 is first re-opened.

The cleaning of the drain line 26 also improves the capacity of the drain line 26 to transport drain liquids, and reduces the risk of a blockage developing in drain line 26 from a build-up of matter 42.

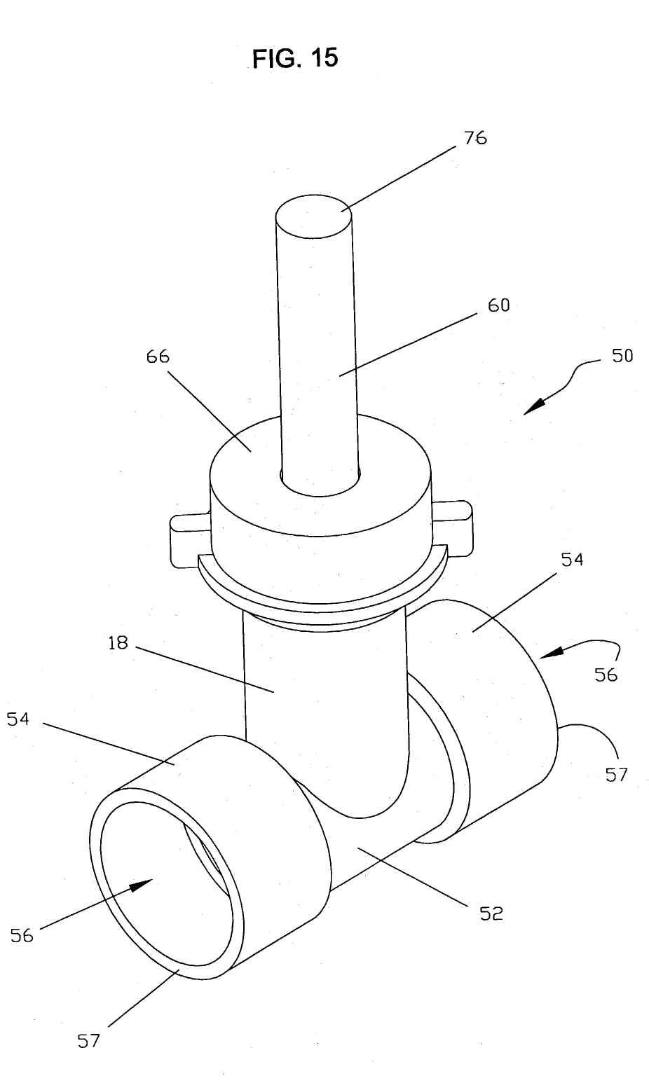

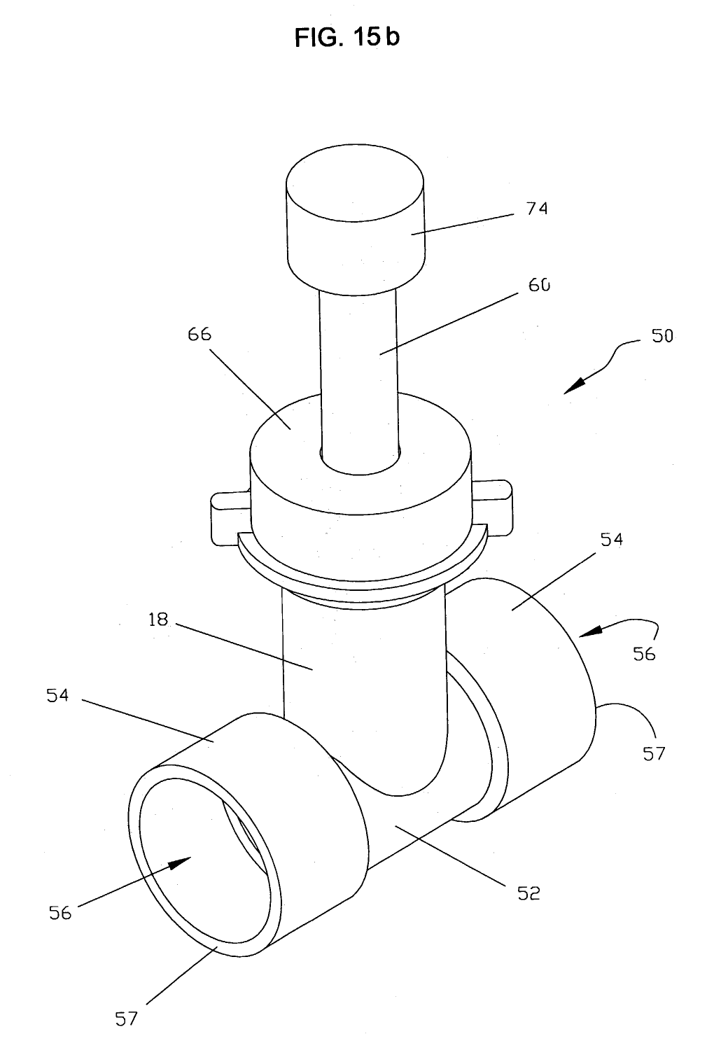

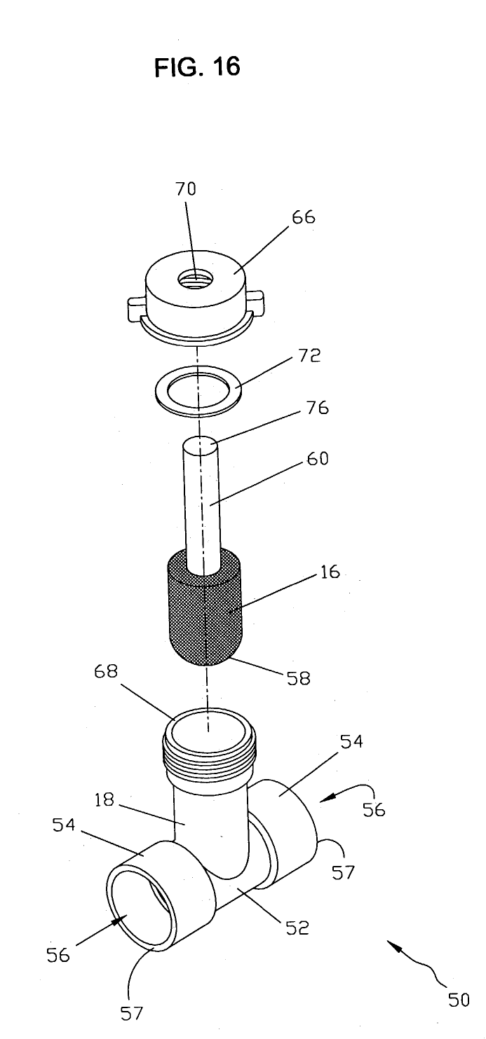

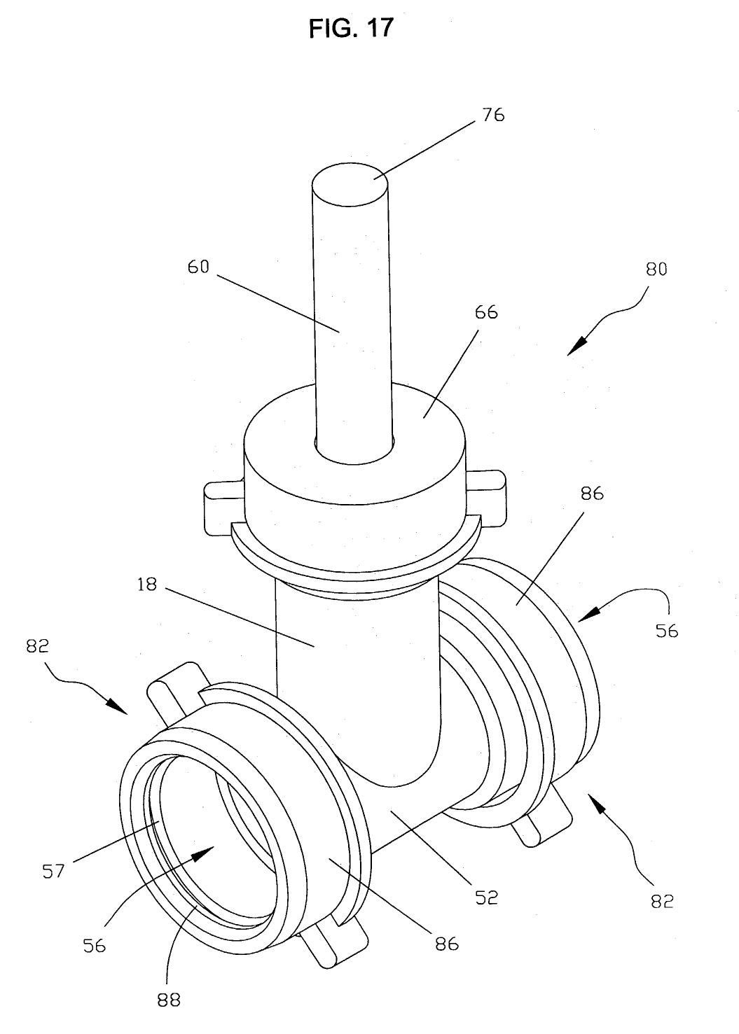

Reference is made to FIG. 15, which shows a plumbing trap after-valve, or cleaning assistance apparatus 50 in accordance with another embodiment of the present invention. Valve 50 is similar to valve 10, and includes the plunger 16 (see FIG. 16), the plunger housing 18, and a pass-through conduit 52, which has, on each end a connector 54 for connecting the valve 50 in-line in a drain line.

The connectors 54 may be soldered, glued or the like, onto associated portions of drain line that have been inserted into an opening 56 at each end 57 of the pass-through conduit 52. Alternatively, the connectors 54 may be any suitable means for connecting the valve 50 to a drain line.

An exploded perspective view of the plumbing trap after-valve 50 is shown in FIG. 16. The plunger 16 may be generally cylindrically-shaped, and may have an outside diameter that is slightly larger than the internal diameter of the plunger housing 18. The plunger 16 is made of material that is soft but resilient (such as sponge rubber or plastic) so that it can slide smoothly, but tightly, against the inside wall of the plunger housing 18 when the plunger 16 is inserted into the plunger housing 18. This friction fit ensures that the plunger 16 remains in position at any desired position inside the plunger housing 18, and also provides a substantially watertight, and airtight, seal between the plunger 16 and the inside wall of the plunger housing 18 when the plunger 16 is in any position therein. The end 58 of the plunger 16 may be hemispherical for mating tightly against the inside wall of the pass-through conduit 52, for sealing off the pass-through conduit 52 against liquid flow therethrough.

The generally cylindrical shape of the plunger 16 permits the plunger 16 to be rotated within the valve 10 or 50 so that any selected portion of the plunger surface can be positioned towards the upstream side of the valve 10 or 50. In this way, the useful service life of the plunger 16 can be extended.

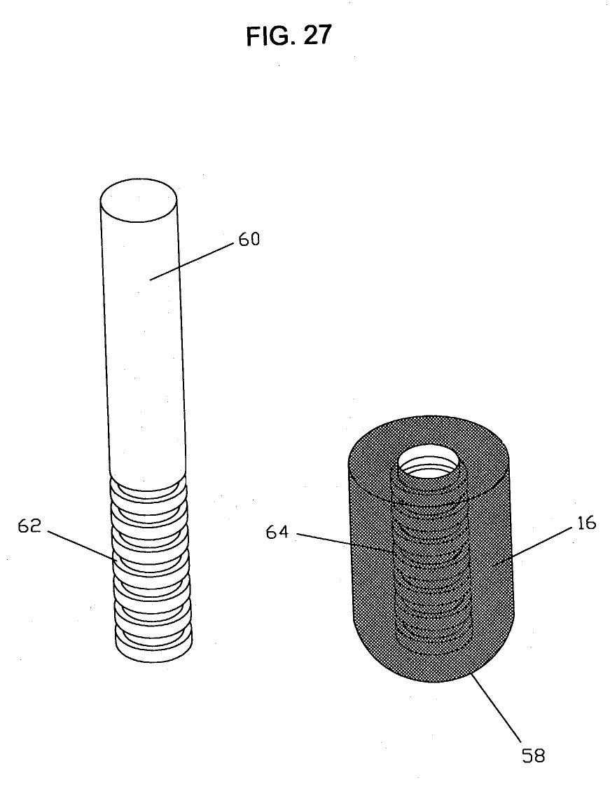

The plunger 16 may have a handle 60 firmly attached thereto. The handle 60 is the means whereby the plunger 16 is moved into the open and closed positions. The attachment between the plunger 16 and the handle 60 may be made along the full length of that portion of the handle 60 that is inside the plunger 16 to reduce any distortions of the plunger 16 that could interfere with the smooth movement of the plunger 16 inside of the plunger housing 18. This form of attachment may be attained by means of gluing or fusing the plunger 16 onto the handle 60, or the like. Alternatively, as shown in FIG. 27, the handle 60 may include a series of ridges 62 that mate with a matching series of ridges 64 that may be molded or otherwise formed into the inside cavity of the plunger 16.

The plunger 16 may be made from a smooth-skinned sponge rubber or plastic material that is soft, and resilient, and is capable of withstanding contact with typical cleaning solution chemicals.

The plunger housing 18 may be formed integrally with the pass-through conduit 52. The plunger housing 18 may join to the pass-through conduit 52 perpendicularly or at any suitable angle. An end cap 66 may be removably mountable to the free end 68 of the plunger housing 18. For example, the end cap 66 may be threaded for mating with a corresponding threaded surface at the free end 68. Alternatively, any suitable releasable connection may be used. By providing a releasable connection for end cap 66, end cap 66 may be removed so that the plunger 16 can be accessed for replacement or maintenance.

The end cap 66 may have a hole 70 therethrough at its center for the pass-through of the handle 60. The end cap 66 provides a sliding engagement with the handle 60. An optional washer 72 may be included between the end cap 66 and the free end 68 to provide a cushion against which the end cap 66 would be tightened.

Optionally, as shown in FIG. 15b, a detachable knob 74 may be fastened onto the free end 76 of the handle 60 to provide a better grip for a user. The knob 74 may be detachable to permit the pass-through of the handle 60 through hole 70 during assembly or disassembly of the valve 50.

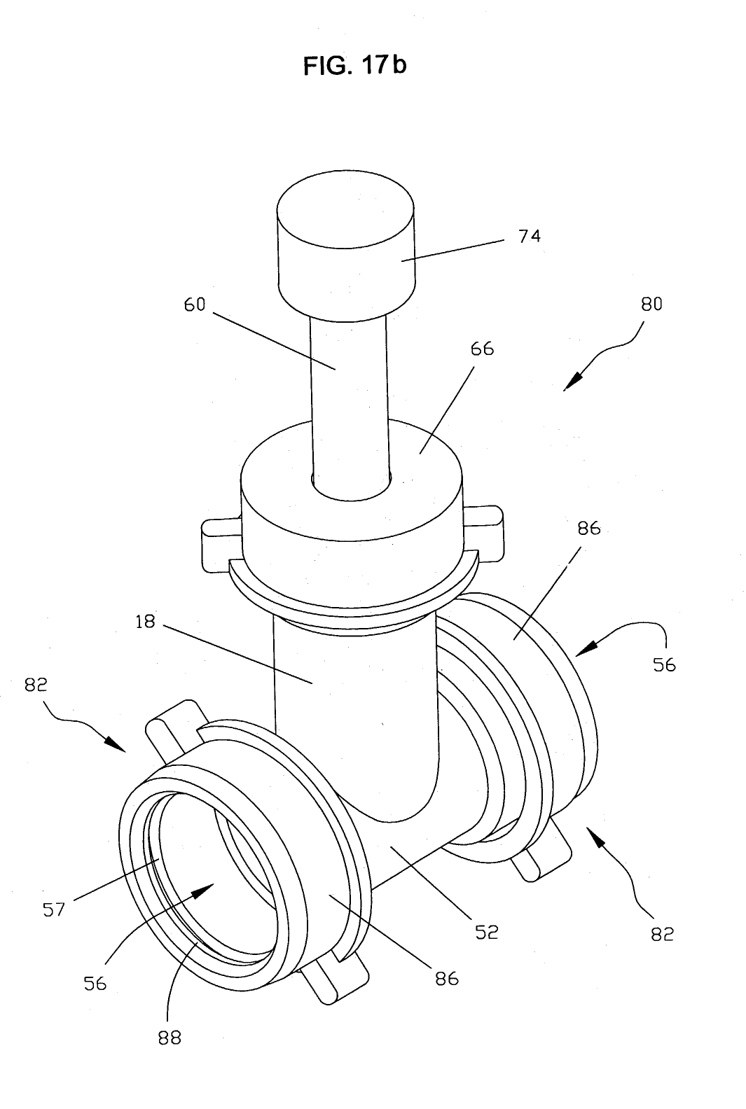

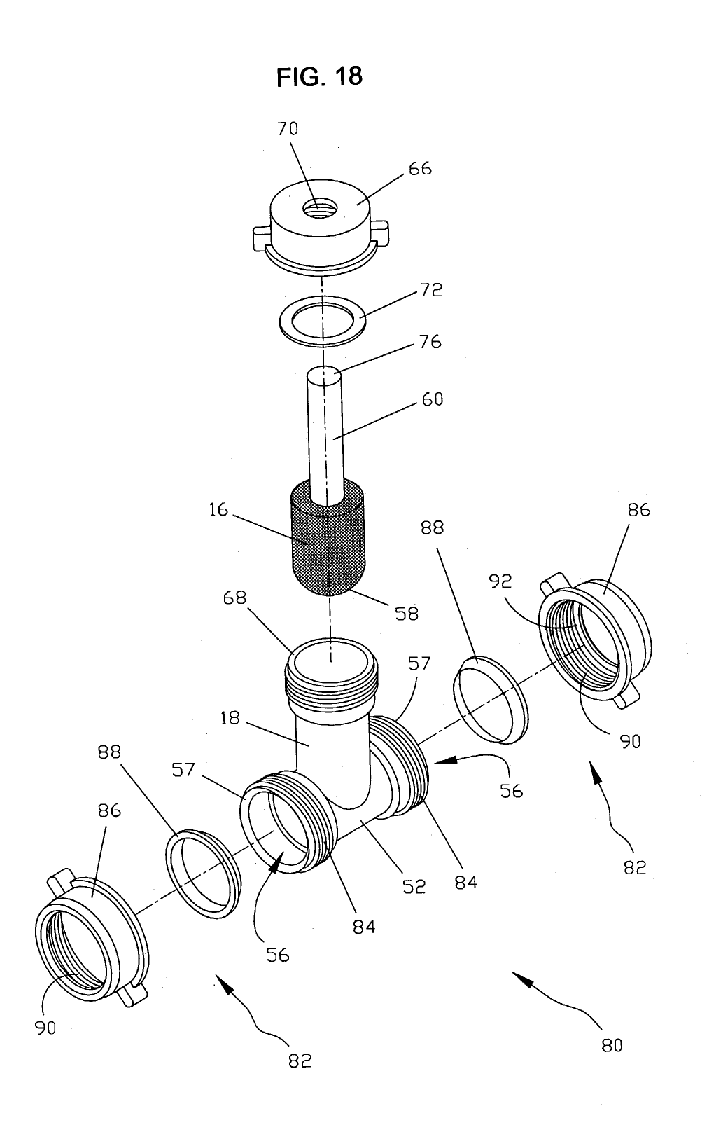

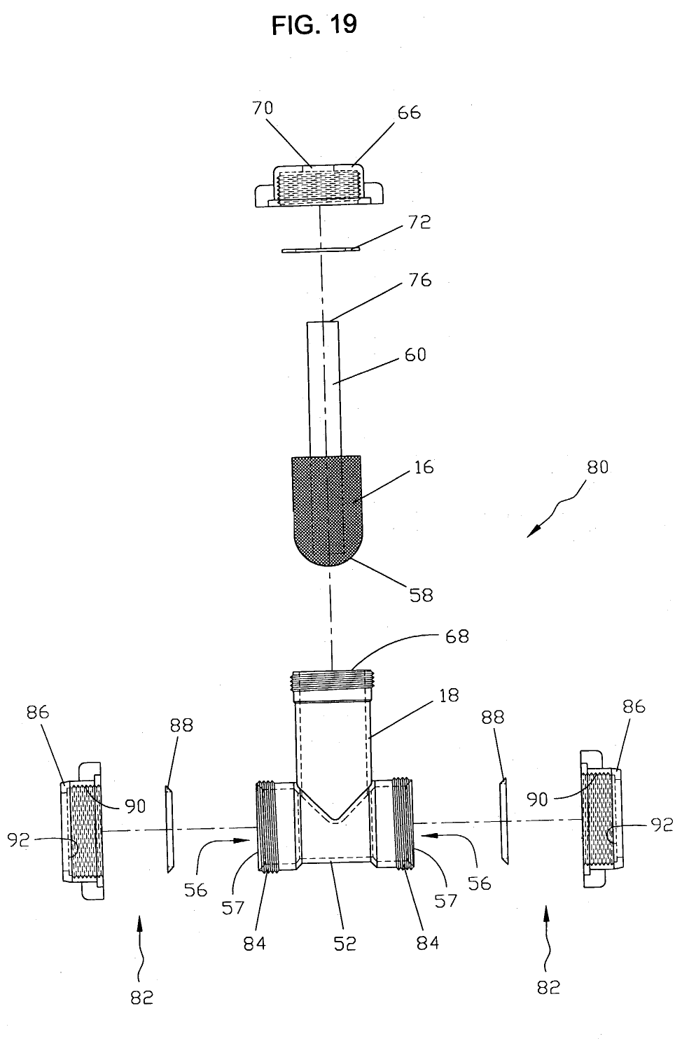

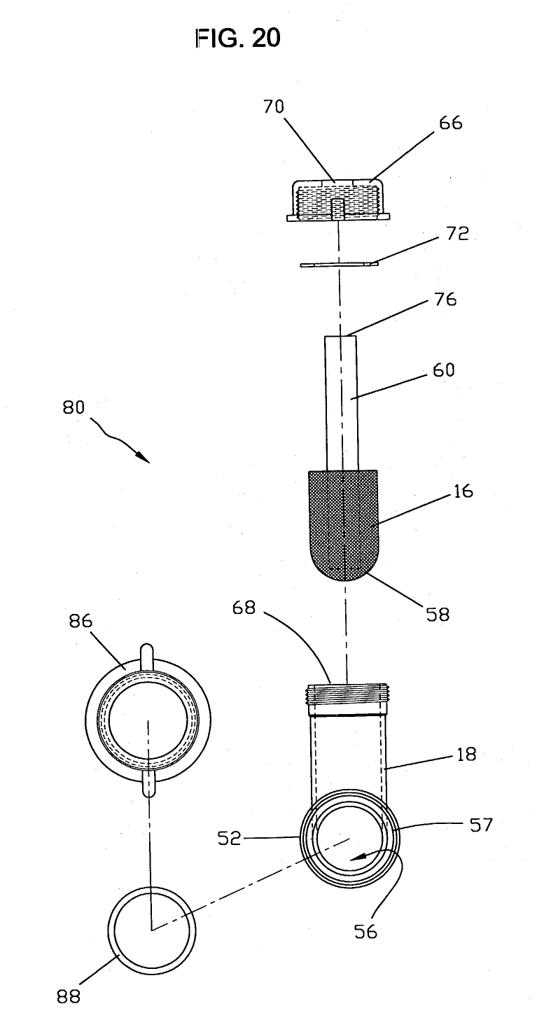

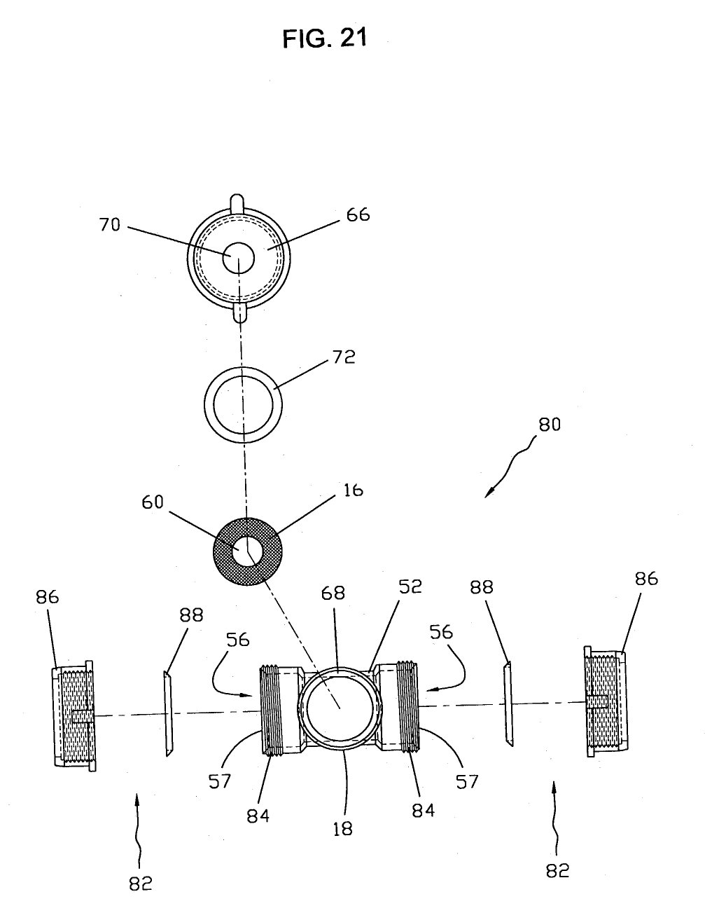

Reference is made to FIG. 17, and more particularly to FIGS. 18, 19, 20 and 21, which show a plumbing trap after-valve or cleaning assistance apparatus 80 in accordance with another embodiment of the present invention. The valve 80 is similar to the valve 50 except that the valve 80 includes a compression connector 82 which mates with a threaded portion 84 adjacent each end 57 of the pass-through conduit 52. The compression connector 82 includes a sleeve 86 and a wedge-shaped packing ring 88. The sleeve 86 has an internal threaded portion 90, which mates with one of the threaded portions 84. The sleeve 86 includes an internal shoulder 92 at its outer end.

As the sleeve 86 is tightened on the threaded portion 84, the internal shoulder 92 compresses the wedge-shaped packing ring 88 against the end 57. The compression of the packing ring 88 causes the packing ring to extend radially inwardly, for sealing against the outside wall of a drain line inserted into the opening 56.

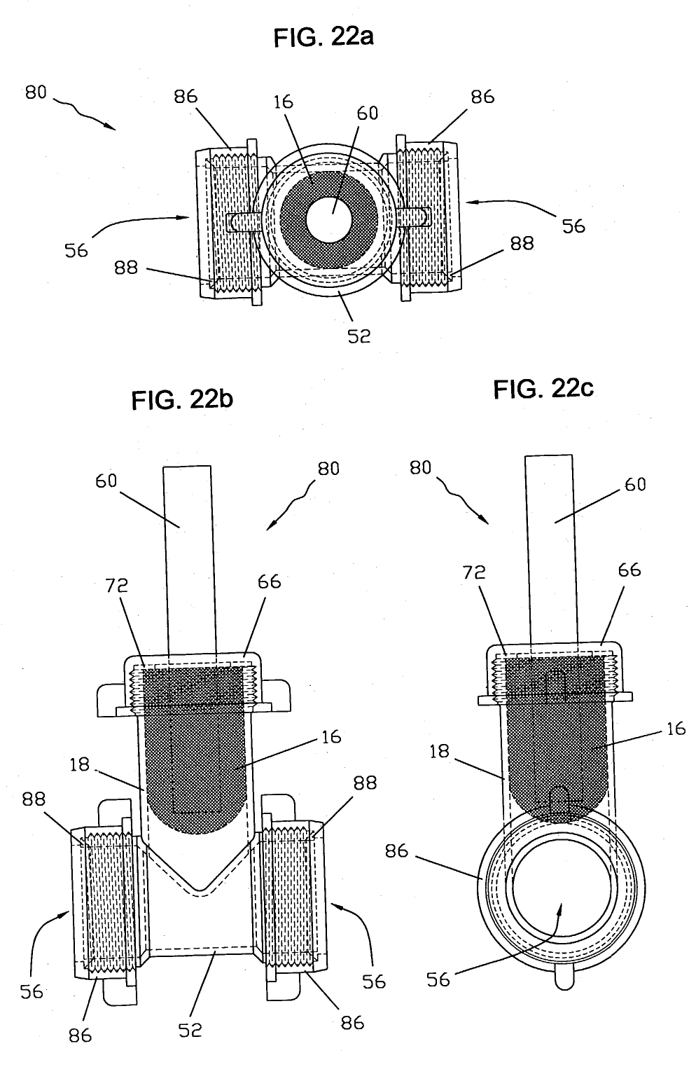

Reference is made to FIGS. 22a, 22b and 22c, which show a top view, a side view, and an end view of the valve 80 after it has been assembled. As shown, the handle 60 has been pulled fully outwards so that the plunger 16 is positioned entirely within the plunger housing 18, so that the pass-through conduit 52 is clear of any obstruction. This is the open position of the valve 80.

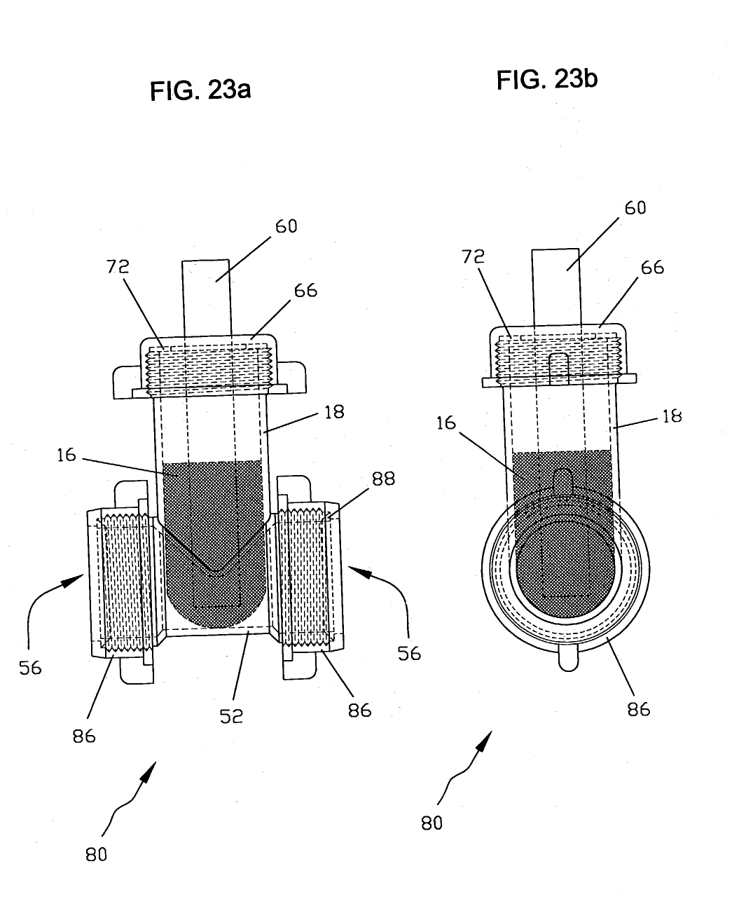

The closed position of the assembled valve 80 is shown in FIGS. 23a and 23b. In this case, the handle 60 has been pushed fully downwards so that the plunger 16 is positioned partly within the plunger housing 18 and partly within the pass-through conduit 52. The portion of the plunger 16 that is within the pass-through conduit 52 is for blocking off the flow of drain liquids through the pass-through conduit 52. The portion of the plunger 16 that is within the plunger housing 18 is for providing a watertight seal between the pass-through conduit 52 and the portion of the plunger housing 18 that is above the plunger 16.

The foregoing has been a description of a plumbing trap after-valve that would be a totally separate and self-contained device, which can be installed as a unit, in order to be part of a plumbing system. This can be easily done by connecting onto pipes with various connection means that use either soldered, glued, or compression joints.

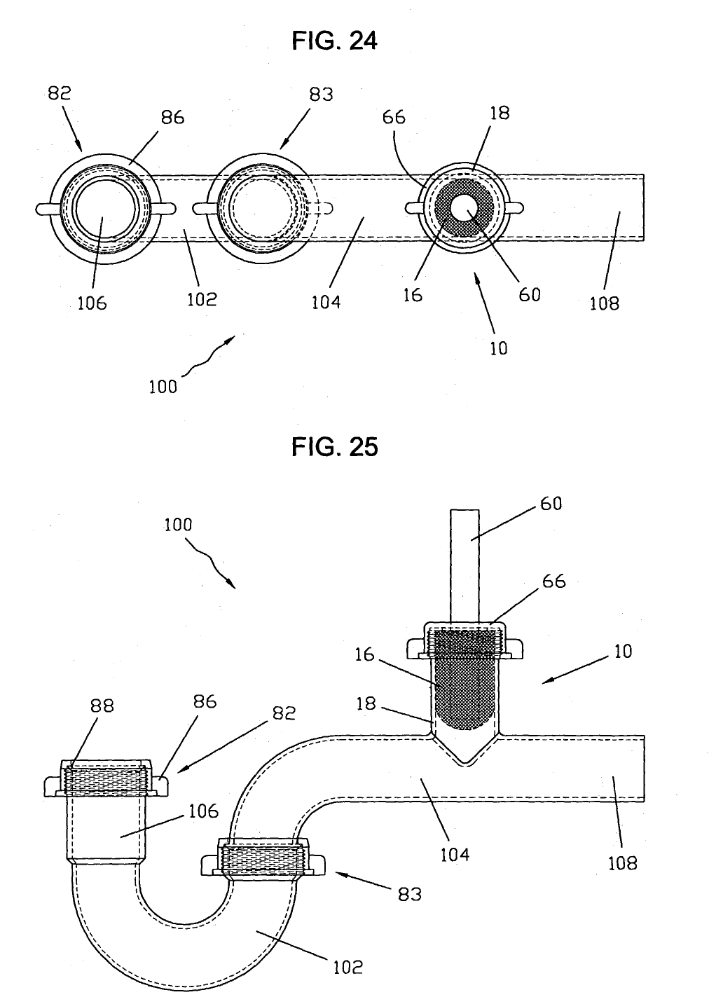

Alternatively, an after-valve could be incorporated into a kit of parts for a plumbing trap assembly so as to form a combined trap and valve unit 100. FIG. 24 shows a top view of such a combination, and FIG. 25 shows a side view of the combination with the valve being in the fully open position. The combined unit 100 includes a trap assembly 102, a substantially horizontal section of drain line 104 and the plumbing trap after-valve 10. The trap assembly 102 may have connection means that utilize compression connectors 82 similar to those described with the valve 80, but it may alternatively have connection means that are soldered, glued, or the like, such as those that have been described with the valve 50.

The valve 10 is attached to the top of the horizontal drain line section 104, downstream from the trap assembly 102. The horizontal drain line section 104 and the trap assembly 102 may be connected together by means of a different kind of compression connector 83, which tightens a union-type joint between them to provide a watertight seal. In this case, a vertical tail pipe from the drain of a single sink, or a vertical pipe from the drain line of a double sink, would be inserted into the connector 82 in the upstream end 106 of the trap assembly 102 and a watertight seal would be provided when the sleeve 86 is tightened to compress the packing ring 88 against the inserted pipe, as has been described earlier. Also in this case, the downstream end 108 of the combined trap and after-valve unit 100 may fit into a similar type of compression joint to that used at the upstream end 106, or by some other means, for connection into the vented drainage system of the house. It will also be understood that the horizontal drain line section 104 and the trap assembly 102 could be integral with one another, with suitable connection fittings at each end.

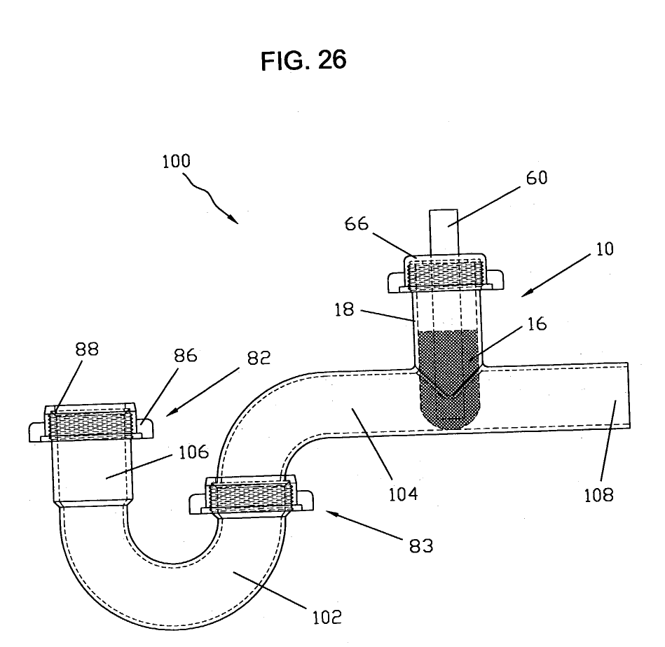

With the valve handle 60 pulled outwards, the plunger 16 will be entirely contained within the plunger housing 18, and the valve 10 will be in its fully open position. When the valve handle 60 is pushed inwards, the plunger 16 will block off the horizontal drain line section 104, as shown in FIG. 26, and the valve 10 will be in its fully closed position.

Installation of a shut-off valve, such as the valves 10, 50 or 80 upstream from a plumbing trap, within a plumbing trap itself, or preferably downstream from a plumbing trap, for the purpose of selectively preventing the normal passage of waste water through a drain line, facilitates the cleaning of the drain line with a cleaning solution, by permitting the cleaning solution a suitable residence time in contact with matter that is built up on the inside walls of the drain line.

The valves 10, 50 and 80 provide a simple way to shut off waste water flow, while not interfering to the free passage of waste water when fully open. The valves 10, 50 and 80 are easy to operate and to maintain, in that the plunger and associated handle are the only moving parts, and can easily be replaced.

All of the parts of the valves 10, 50 and 80, except for the washer 72 and the plunger 16 may be molded from a hard plastic, or alternatively they may be formed from metal, or some other suitable material.

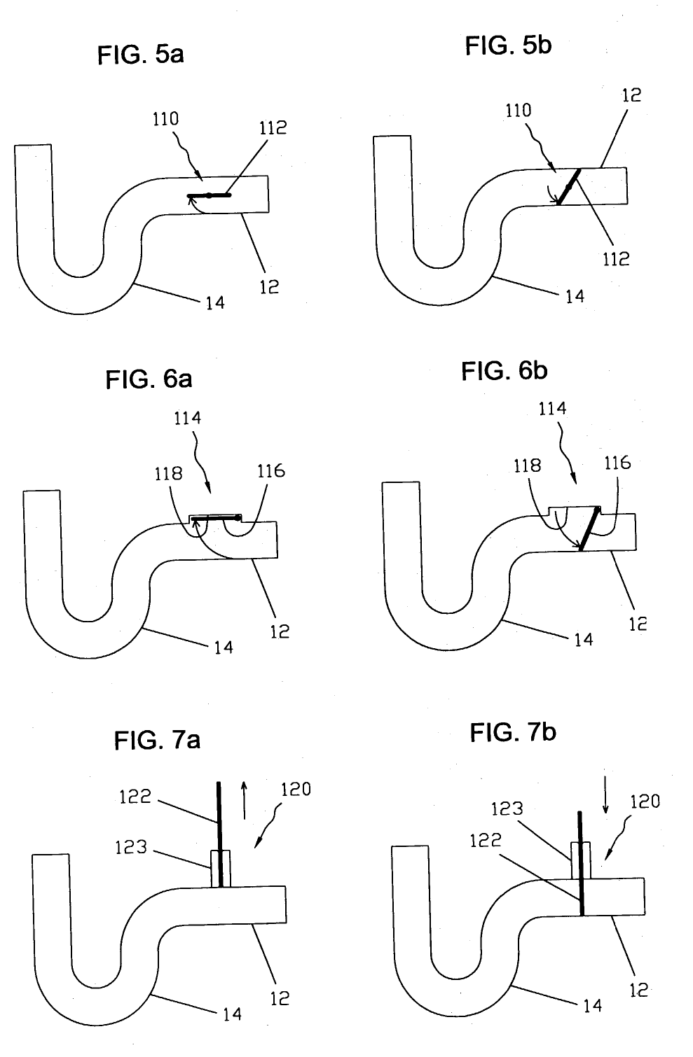

Reference is made to FIGS. 5a and 5b, which show a plumbing trap after-valve 110 in accordance with another embodiment of the present invention. The plumbing trap after-valve 110 may have a flap 112 that is centrally pivoted inside a drain line 12 downstream from a plumbing trap 14.

Reference is made to FIGS. 6a and 6b which show a plumbing trap after-valve 114 in accordance with another embodiment of the present invention. The plumbing trap after-valve 114 has an end-pivoted flap 116 which swings up into a cavity 118 located above the drain line 12 when the valve 114 is open so that there is no obstruction to the free flow of waste water in the open position.

Reference is made to FIGS. 7a and 7b, which show a plumbing trap after-valve 120 in accordance with another embodiment of the present invention. The plumbing trap after-valve 120 comprises a sliding plate 122 that may be located on top of the drain line 12, downstream from the trap 14. The plate 122 can be pushed inwards in a guide shaft 123 in order to close off the drain line 12, and can be pulled outwards in the guide shaft 123 in order to open the drain line 12 to waste water flow.

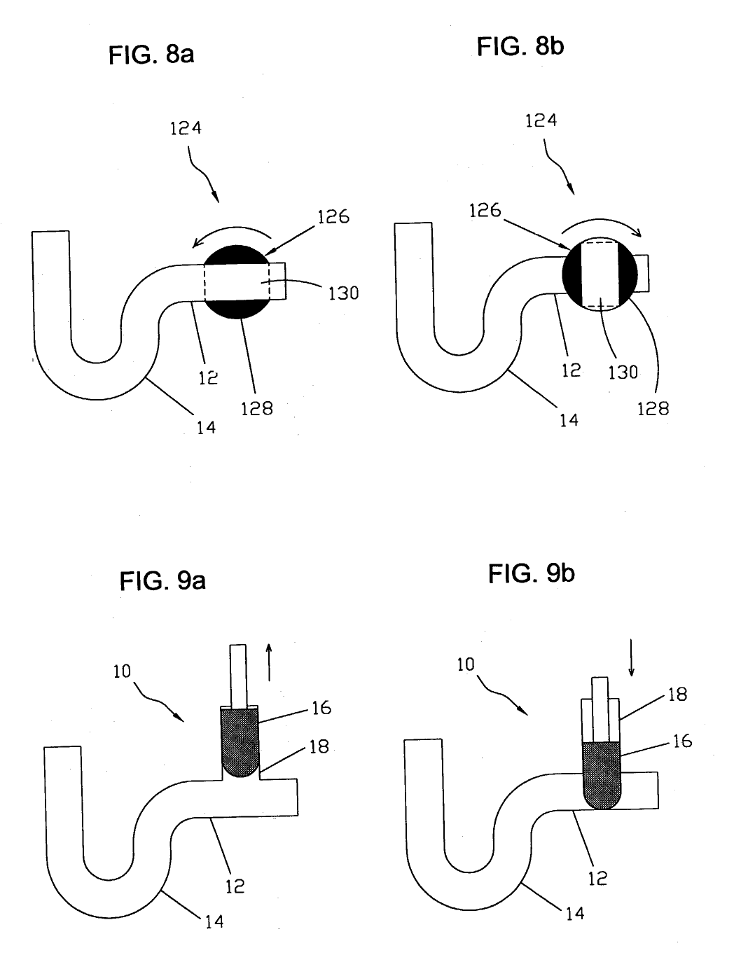

Reference is made to FIGS. 8a and 8b, which show a plumbing trap after-valve 124 in accordance with another embodiment of the present invention. The plumbing trap after-valve 124 comprises a rotatable cylindrical plug 126 positioned downstream from the trap 14. The plug 126 has an outer cylindrical wall 128 and a conduit 130 therethrough, and can be rotated so that either the cylindrical wall 128 is positioned within the drain line 12 to close the valve 124, or the conduit 130 is aligned with the drain line 12 to open the valve 124.

The plumbing trap after-valve may be installed downstream from the plumbing traps of other household appliances, or downstream from the plumbing traps on drain lines in factories, hospitals and institutions.

While the above description constitutes the preferred embodiments, it will be appreciated that the present invention is susceptible to modification and change without departing from the fair meaning of the accompanying claims.

I claim:

1. A plumbing drain system comprising:
a drain line having a drain inlet;
a trap, downstream from the drain inlet, for holding a sufficient volume of liquid to close off the drain line; and
a valve situated in the drain line, downstream from the drain inlet, the valve being positionable between a normally open position wherein liquid flow is permitted and a closed position wherein liquid flow through the drain line is substantially prevented, whereby, in use, a portion of the drain line upstream of the valve and including the trap can be closed off, to retain a drain line cleaning solution for a selected period of time.

2. A plumbing drain system as claimed in claim 1, wherein the trap comprises a p-trap situated in the drain line downstream from the drain inlet, the p-trap having an inlet side and an outlet side, and the p-trap being adapted to hold liquid at a liquid level on the inlet side and the outlet side, wherein the valve is situated downstream from the p-trap.

3. A plumbing drain system as claimed in claim 1, further comprising a vent line connected to and extending from the drain line, wherein the valve is situated upstream of the vent line.

4. A plumbing drain system as claimed in claim 3, wherein the valve is situated immediately downstream from the trap.

5. A plumbing system as claimed in claim 3, wherein the drain line includes a generally vertical portion extending from the drain inlet to the trap, and a generally horizontal portion extending from the trap to the valve.

6. A plumbing system as claimed in claim 1, wherein the valve includes a closure member movable between the closed position in which liquid flows prevented and the normally open position in which liquid flows permitted.

7. A plumbing drain system as claimed in claim 6, wherein the valve includes:
a housing having a pass-through conduit and a plunger housing that intersects the pass-through conduit; and
a plunger having a plunger body, the plunger body providing the closure member and being movably mounted in the plunger housing and sealingly engaging with the plunger housing to prevent liquid flow and therefrom, the plunger being movable in the plunger housing between an extended position, in the closed position of the valve, wherein the plunger body extends into the pass-through conduit to substantially block liquid flow therethrough, and a retracted position, in the open position of the valve, wherein the plunger is substantially removed from the pass-through conduit to permit liquid flow therethrough, the plunger further including a handle for moving the plunger body between the retracted and the extended positions.

8. A plumbing drain system as claimed in claim 7, wherein the plunger includes a plunger handle extending out from a plunger housing, adapted to extend vertically above the housing, and in use, to permit manual operation of the valve.

9. A cleaning assistance apparatus for use in a drain line having a drain inlet, the cleaning assistance apparatus comprising:
a valve, the valve being mountable in the drain line, downstream from the drain inlet, the valve being positionable between an open position wherein flow is permitted through the drain line and a closed position wherein flow is substantially prevented through the drain line, whereby, in use, a portion of the drain line upstream of the valve can be closed off, to hold a drain line cleaning solution for a selected period of time.

10. A cleaning assistance apparatus as claimed in claim 9, wherein the valve includes:
a housing having a pass-through conduit and a closure housing that intersects the pass-through conduit, the pass-through conduit having a connector at each end for connecting the housing to a drain line; and
a closure member, the closure member being movably mounted in the closure housing and sealingly engaged with the closure housing to prevent liquid flow out therefrom, the closure member being movable in the closure housing between the closed position wherein the closure member extends across the pass-through conduit to substantially block liquid flow therethrough, and the open position wherein the closure member is substantially retracted from the pass-through conduit to permit liquid flow therethrough, the closure member further including a handle for moving the closure member between the retracted and the closed positions.

11. A cleaning assistance apparatus as claimed in claim 10, wherein the closure member comprises a flap that is pivoted above an axis extending substantially centrally across the closure housing, for movement between the open and closed positions.

12. A cleaning assistance apparatus as claimed in claim 10, wherein the closure member comprises an end-pivoted flap, and wherein the closure housing includes a cavity for accommodating the end-pivoted flap, the end-pivoted flap being movable between the closed position closing off the closure housing to fluid flow and the open position in which the end-pivoted flap is accommodated in the cavity.

13. A cleaning assistance apparatus as claimed in claim 10, wherein the closure member comprises a sliding plate, slidably mounted in a guide shaft extending through the closure housing, for movement between the open and closed positions.

14. A cleaning assistance apparatus as claimed in claim 10, wherein the closure member comprises a rotatable cylindrical plug, including a conduit therethrough, the plug being rotatable between the open position in which the conduit is aligned with a pass-through conduit and a closed position in which the conduit is closed off from the pass-through conduit.

15. A cleaning assistance apparatus as claimed in claim 10, wherein the plunger body and the handle have a longitudinal axis and the plunger body and handle are generally cylindrical about the longitudinal axis, so that the plunger is rotatable about the longitudinal axis to expose a selected portion of the plunger body to liquids upstream from the plunger body in drain line.

16. A kit of parts for use with a cleaning solution to clean a drain line, the drain line having a drain inlet, the kit of parts comprising:
a section of drain line; and
a valve integrally mounted in the section of drain line, the valve including a plunger housing and a plunger, the plunger housing being connected to and extending from the section of drain line, the plunger having a plunger body, the plunger body being movably mounted in the plunger housing and sealingly engaged with the plunger housing to prevent liquid flow therethrough, the plunger body being movable in the plunger housing between an extended position wherein the plunger body extends into the section of drain line to substantially block liquid flow therethrough, and a retracted position wherein the plunger is substantially removed from the section of drain line to permit liquid flow therethrough, the plunger further including a handle for moving the plunger body between the retracted and the extended positions.

17. A kit of parts as claimed in claim 16, further comprising a p-trap mounted to the section of drain line.

18. A method for cleaning a drain line system, the drain line system including a drain line having a drain inlet, the drain line system including a trap situated in the drain line, the method comprising:
closing the drain line off to flow therethrough, at a point of closure that is downstream from the trap;
filling the drain line with cleaning solution, so that substantially all of the drain line upstream of the point of closure is filled with cleaning solution; and
opening the drain line to flow therethrough after a selected period of time corresponding to the time required for the cleaning solution to clean the drain line.

19. A method for cleaning a drain line system as claimed in claim 18, wherein the drain line system comprises a vent line connected to and extending from the drain line downstream from the trap, and the point of closure is upstream of the vent line.

20. A method for cleaning a drain line system as claimed in claim 18, further comprising flushing the drain line system with water after opening the drain line, to remove the cleaning solution and any debris suspended therein from the drain line system.
